(19) United States
(12) Patent Application Publication
(10) Pub. No.: US 2005/0247557 A1
(43) Pub. Date: Nov. 10, 2005

(54) Electrolytic water purifier

(75) Inventor: Shigeo Tochikubo, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TYK CORPORATION, Tokyo (JP)

(21) Appl. No.: 10/823,765

(22) Filed: Apr. 14, 2004

(51) Int. Cl. C02F 1/46

(52) U.S. Cl. 204/242

(57) ABSTRACT

This provides an electrolytic water purifier having advantages in adsorbing gas produced by electrolyzation to pores of a porous water-purifying member. This purifier includes a container 1 having a water supplying room 14, a porous water-purifying member 3 disposed in the water supplying room 14, a water supplying portion 29 supplying water to the water supplying room 14, a discharging portion 36 discharging the purified water with the porous water-purifying member 3. The porous water-purifying member 3 is divided into at least porous water-purifying members 4, 5 in a radial direction to form an annular clearance 6. The first porous water-purifying member 4 is connected to the first feeder terminal 34 to be the first electrode A1. The second porous water-purifying member 5 is connected to the second feeder terminal 35 to be the second electrode A2. By applying voltage to the electrode A1, A2, water in the annular clearance 6 is electrolyzed and produced gas is adsorbed to the pores of the porous water-purifying member 3.

### BACKGROUND OF THE INVENTION

1. Field of the Invention

The present invention relates to an electrolytic water purifier, which electrolyzes water by applying voltages to a porous water-purifying member having a plurality of pores. Especially, the present invention can be adapted to an electrolytic water purifier, which has advantages in efficiently adsorbing the gas produced by electrolyzation to the pores of the porous water-purifying member. It especially adsorbs the gas immediately after electrolyzation, which is generally said to have activation. The present invention can be adapted to an electrolytic water purifier for domestic use, medical use, industrial use and the like.

2. Description of the Related Art

There has been provided a water purifier includes: a container having a water supplying room divided by an inner wall surface; a porous water-purifying member having ability of water purification, disposed in the water supplying room of the container; a water supplying portion supplying water to the water supplying room of the container; and a water discharging portion discharging water outside the device, purified with the porous water-purifying member in the water supplying room of the container. According to this water purifier, water is purified by the porous water-purifying member.

Moreover, according to the valid data of a recent document, the gaseous hydrogen immediately after electrolyzation is activated and it is reported to be effective to organism and the like, as compared to the ordinal gas (generally gaseous hydrogen) after a considerable time has passed from electrolyzation. Namely, super fine sized (generally 3-100 nm) gaseous particles (generally gaseous hydrogen particles) identified immediately after electrolyzation is activated and it is reported to be effective to organism and the like, as compared to the ordinal gas (hydrogen: generally 10-30 μm) after a considerable time has passed from electrolyzation.

The present invention has developed as a part of the above mentioned water purifier having a porous water-purifying member. It is directed to providing an electrolytic water purifier, which has advantages in adsorbing the gas produced by electrolyzation to the pores of the porous water-purifying member. Especially, it is directed to providing an electrolytic water purifier, which has advantages in adsorbing the activated gas immediately after electrolyzation, which is said to be effective to organism, to the pores of the porous water-purifying member.

Further, when the alternating current voltage is applied, it is directed to providing an electrolytic water purifier which has advantages in suppressing the phenomena of anode corrosion occurring when applying the direct current voltage, and suppressing the deposition of products such as calcium carbonate, magnesium carbonate, etc. on the part of cathode (negative pole).

### SUMMARY OF THE INVENTION

The electrolytic water purifier of the present invention comprises: a container having an inner wall surface and a water supplying room formed of the inner wall surface; a porous water-purifying member having a plurality of pores with water purifying ability, disposed in the water supplying room of the container; a water supplying portion placed in the container and supplying water to the water supplying room of the container; and a discharging portion placed in the container and discharging water purified with the porous water-purifying member of the water supplying room of the container to outside the container; wherein the porous water-purifying member is divided in a radial direction into at least a first porous water-purifying member and a second porous water-purifying member to form an annular clearance, and the first porous water-purifying member is connected to a first feeder terminal to be a first electrode and the second porous water-purifying member is connected to a second feeder terminal to be a second electrode, and by applying voltage to the first and second electrodes, water in the annular clearance is electrolyzed to produce gas to be adsorbed to the pores of the porous water-purifying member.

In accordance with the electrolytic water purifier of the present invention, the porous water-purifying member is divided into at least two tubular parts in a radial direction to form an annular clearance. Accordingly, it can be divided into two parts in a radial direction. Or it can be divided into three or four parts in a radial direction depending on the condition. The first porous water-purifying member is connected to a first feeder terminal to be the first electrode: the second porous water-purifying member, which is placed opposite the first porous water-purifying member, is connected to a second feeder terminal to be the second electrode. By applying voltage to the first and the second electrodes, water in the annular clearance is electrolyzed. That is, the annular clearance is used as an electrolytic room. In this case, since the first and the second porous water-purifying members are placed near the annular clearance, the gas immediately after produced by electrolyzation is readily adsorbed to the pores of the first and the second porous water-purifying members in the early stage. In this case, it has an advantage in diffusing and adsorbing the gas immediately after produced by electrolyzation to the pores of the first and the second porous water-purifying members.

According to the above mentioned document, the gas immediately after produced by electrolyzation has activity and it is said to have good influences on organism. That is, it is said the gas immediately after produced by electrolyzation is super fine sized and it has good influences on organism, as compared to one after long time has passed.

In accordance with the electrolytic water purifier of the present invention, it is possible to effectively raise a pressure in the annular clearance used as an electrolytic room when gas is generated by electrolyzation, since a porous water-purifying member with a plurality of pores has resistance in gas permeation. When the pressure rises in the annular clearance used as an electrolytic room, the gas in the annular clearance used as an electrolytic room can be easily diffused inside the porous water-purifying members by the increased pressure and the gas can be easily adsorbed to the porous water-purifying members.

In accordance with the electrolytic water purifier of the present invention, the porous water-purifying member is divided into at least two tubular parts in a radial direction to form an annular clearance. The first porous water-purifying member is connected to a first feeder terminal to be the first electrode and the second porous water-purifying member is connected to a second feeder terminal to be the second electrode. According to this construction, it is possible to enlarge the surface area of the wall forming the annular clearance used as an electrolytic room, so it is also possible to enlarge an electrolytic area in the porous water-purifying member. This has advantages in heightening the ability of electrolyzation in the annular clearance used as an electrolytic room. Moreover, since it is possible to enlarge a gas permeation area of the porous water-purifying member which adsorbs the gas to the porous water-purifying member, it has advantages in adsorbing, to the pores of the porous water-purifying member, materials such as gas generated by water electrolyzation in the annular clearance used as an electrolytic room. Generally, it is said that the gas such as hydrogen, etc. immediately after produced by electrolyzation is activated and has good influences on organism. In accordance with the electrolytic water purifier of the present invention, it has advantages in effectively adsorbing the gas immediately after produced by electrolyzation, activated and said to be good for organism, to the first and the second porous water-purifying members, since the annular clearance used as an electrolytic room is formed between the first and the second porous water-purifying members.

Further, in accordance with the electrolytic water purifier of the present invention, when the alternating current voltage is applied to the first and the second electrodes, it has advantages in suppressing the phenomena of anode corrosion occurring when applying the direct current voltage, as well as in suppressing the deposition of products such as calcium carbonate, magnesium carbonate, etc. on the cathode (negative pole), so it has advantages in maintenance and the like. The alternating current voltage can include, for example, sine curve shaped alternating current waveforms or waveforms of sine curve shaped alternating current waveform component added to direct current component.

### BRIEF DESCRIPTION OF DRAWINGS

FIG. 1 is a drawing of the longitudinal section showing an electroytic water purifier in the first embodiment of the present invention.

FIG. 2 is a drawing of the enlarged longitudinal section showing the principal part of the electroytic water purifier in the first embodiment of the present invention.

FIG. 3 is an outside drawing for showing a part of the cross section of the inner side of the first embodiment of the present invention.

FIG. 4A is a representative waveform drawing in applying alternating current voltage.

FIG. 4B is a representative waveform drawing in applying alternating current voltage.

FIG. 4C is a representative waveform drawing in applying alternating current voltage.

FIG. 5A is a representative waveform drawing in applying direct current voltage.

FIG. 6 is a drawing of a longitudinal section showing the principal part of an electroytic water purifier in the fourth embodiment.

FIG. 7 is a drawing of a longitudinal section showing the principal part of an electroytic water purifier in the fifth embodiment.

FIG. 8 is a drawing of a longitudinal section showing an electroytic water purifier in the sixth embodiment.

FIG. 9 is a drawing of a longitudinal section showing the principal part of an electroytic water purifier in the seventh embodiment.

FIG. 10 is a planimetric drawing showing around feeder terminals of an electroytic water purifier in the seventh embodiment.

FIG. 11 is a planimetric drawing showing around feeder terminals of an electroytic water purifier in the eighth embodiment.

### DETAILED DESCRIPTION OF THE PREFERRED EMBODIMENTS

As to the preferred embodiments, at least one of below mentioned embodiments can be adopted.

An electrolytic room can be constructed with an annular clearance formed by the first and the second porous water-purifying members. In this case, the annular clearance being an electrolytic room can pass through or substantially pass through one shaft end to the other shaft end. Further, it is possible to place a closing portion such as a seal cap that closes the end of the annular clearance being an electrolytic room, at the through end of the annular clearance being an electrolytic room in order to close the end of the electrolytic room and increase a pressure in the electrolytic room. In this case, closeness of the annular clearance being an electrolytic room is increased because of the closing portion and accordingly, it is advantageous to increase the pressure of the annular clearance due to the gas generated by electrolyzation in the annular clearance being an electrolytic room. As a result, it can be expected to achieve the effect of enabling to adsorb the gas generated by electrolyzation in the annular clearance being an electrolytic room, especially the gas immediately after electrolyzation, to the pores of the porous water-purifying member at an early stage. It is possible to form a gap keeping element such as a spacer to keep the width of the annular clearance in the electrolytic room as one unit with the closing portion such as a sealing cap. In addition, when width of the annular clearance being an electrolytic room is excessively large, it is difficult for the electrolytic current to flow. Thus, the width of the annular clearance being the electrolytic room can be, for instance, 30 mm or less, 20 mm or less, 10 mm or less, 5 mm or less, 4 mm or less, 2 mm or less depending on the voltage applied.

The first and the second porous water-purifying members can both be tubular shaped. The first porous water-purifying member is connected to a first feeder terminal to be the first electrode and the second porous water-purifying member is connected to a second feeder terminal to be the second electrode. By applying voltage (alternating current or direct current) to the first and the second electrodes, water in the annular clearance is electrolyzed and the produced gas is adsorbed to the pores of the porous water-purifying member. The voltage applied between the first and the second electrodes can be selected suitably, for example, from 1.5 to 25 volt, from 2 to 20 volt, especially from 5 to 7 volt can be selected, however, it should not be limited by these. In this specification, volt and ampere mean effective value in the alternating current.

As a container, it is preferable to be made of corrosion resisting materials such as titanium alloy, stainless steel, high alloy steel, etc. As the below mentioned embodiments, when the first and the second electrodes are conducted, a continuity member which composes a container, etc. tends to be polarized in general. In the part polarized anode (+pole), anode corrosion may occur to metal parts. Also, when the direct current voltage is applied to the first and the second electrodes, anode corrosion may occur to metal parts in the anode (+pole) part depending on the condition. However, when the alternating current voltage, which repeats positive potential and negative potential several times per unit hour, is applied to the first and the second electrodes, potential is changed repeatedly several times per unit hour according to the cycles of oxidation and reduction. Thus, anode corrosion and anode elution can be suppressed as compared to applying the direct current voltage.

Moreover, when applying the direct current voltage to the first and the second electrodes, depending on the condition, products such as calcium carbonate or magnesium carbonate may be deposited on cathode (−pole) as the electrolytic water purifier has been used for long period of time. In order to suppress these depositions, it is preferable to apply the alternating current voltage to the first and the second electrodes, which alternately repeats positive potential and negative potential several times per unit hour.

As the upper limit of the frequency of the alternating current voltage, it is possible to adopt 500 Hz or less, 300 Hz or less, 200 Hz or less, 100 Hz or less, 80 Hz or less. As the lower limit of frequency of the alternating current voltage, 10 Hz or more, 20 Hz or more, 30 Hz or more, 40 Hz or more, 50 Hz or more can be adopted. Considering alternating current voltage generally fed, in the range of 10 to 500 Hz, 20 to 200 Hz, 40 to 70 Hz, especially 50 to 60 Hz can be adopted. To be concrete, 50 Hz or 60 Hz can be adopted like ordinal household ac electrical products.

Consequently, in accordance with the electrolytic water purifier of the present invention, there are no limitations in construction and function of a voltage applying member, as long as it can apply the alternating current or direct current to the first and the second electrodes.

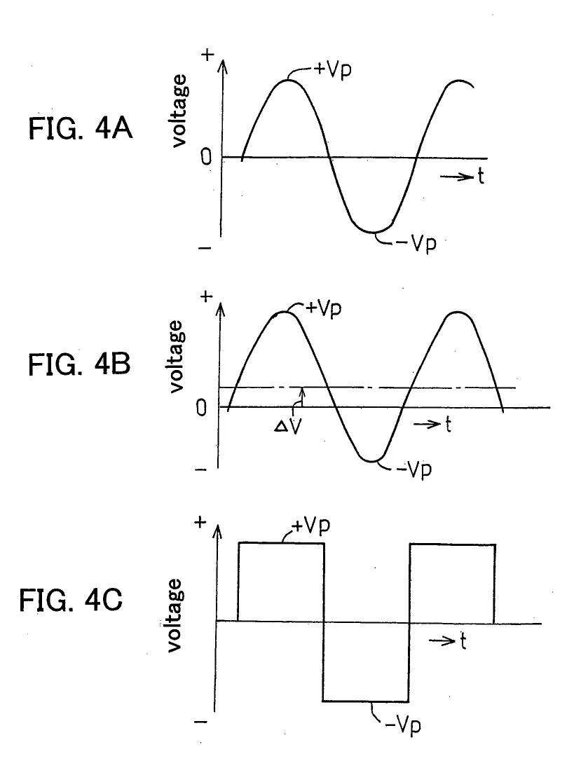

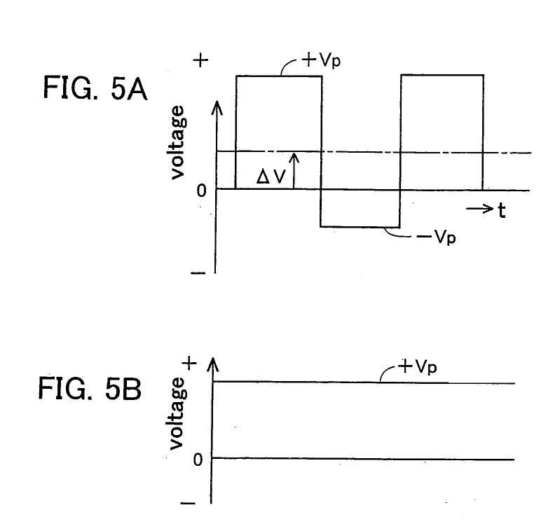

As a representative form to apply voltage to the first and the second electrodes, example forms are shown in FIG. 4A, FIG. 4B, FIG. 5A and FIG. 5B. The ‘t’ in the horizontal axis represents time. According to the alternating current waveform shown in FIG. 4A, positive potential and negative potential alternately repeat in a sine curve shape several times per unit hour. The peak voltage of positive potential +Vp and the peak voltage of negative potential −Vp basically show the same amount except for the signs. According to the alternating current waveform shown in FIG. 4B, positive potential (the peak voltage: +Vp) and negative potential (the peak voltage: −Vp) alternately repeat several times per unit hour, and the peak voltage of positive potential +Vp is ΔV biased due to the direct current components. In addition, either the first electrode or the second electrode can be biased. According to the alternating current waveform shown in FIG. 4C, the rectangular waveform of positive potential and the rectangular waveform of negative potential alternately repeat several times per unit hour. According to the alternating current waveform shown in FIG. 5A, the rectangular waveform of positive potential (the voltage: +Vp) and the rectangular waveform of negative potential (the voltage: −Vp) alternately repeat several times per unit hour, and the peak voltage of positive potential +Vp is ΔV biased due to the direct current components. Further, waveforms of alternating current voltage are not limited to the forms shown in FIG. 4A, FIG. 4B, FIG. 4C and FIG. 5A. FIG. 5B shows a representative direct current waveform in applying voltage to the first and the second electrodes.

A porous water-purifying member has a plurality of pores to exhibit high captivation to extraneous materials such as fungi and the like. The pores are through to each other and they form a permeable layer that permeates water. The pores have water purifying ability as well as the ability to adsorb materials, for instance, the gas such as hydrogen and oxygen produced by electrolyzation. As a porous water-purifying member, it is preferable to utilize carbonaceneous materials (generally carbonaceneous forming) such as an activated carbon being an electric conductor. In this case, a porous water-purifying member can be formed with an activated carbon and a binding agent as prime components. A binding agent can be a resin material or an inorganic material. An activated carbon can be, for instance, powdered, granulated or fibrous.

### EMBODIMENTS

### Embodiment 1

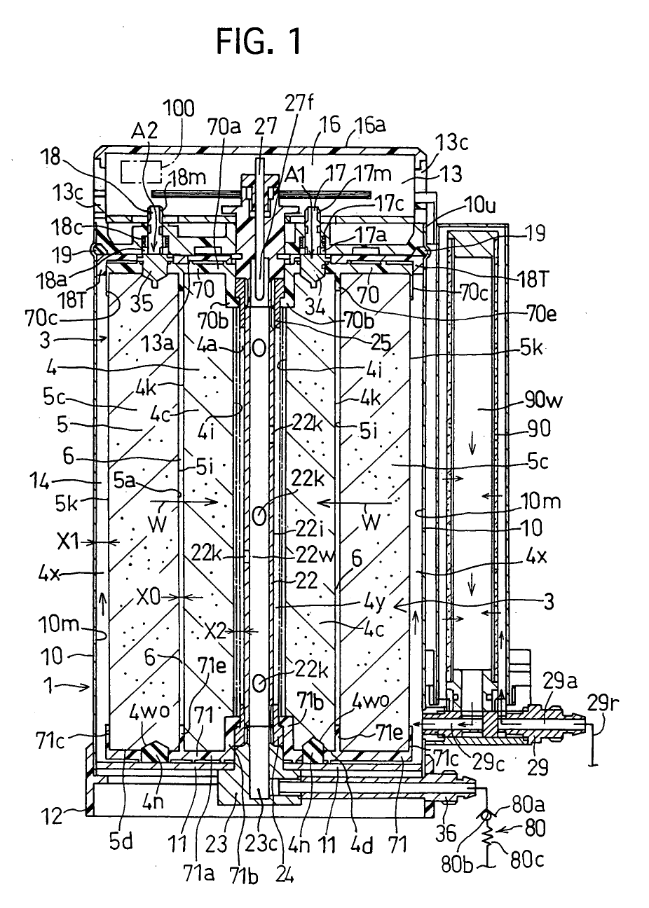

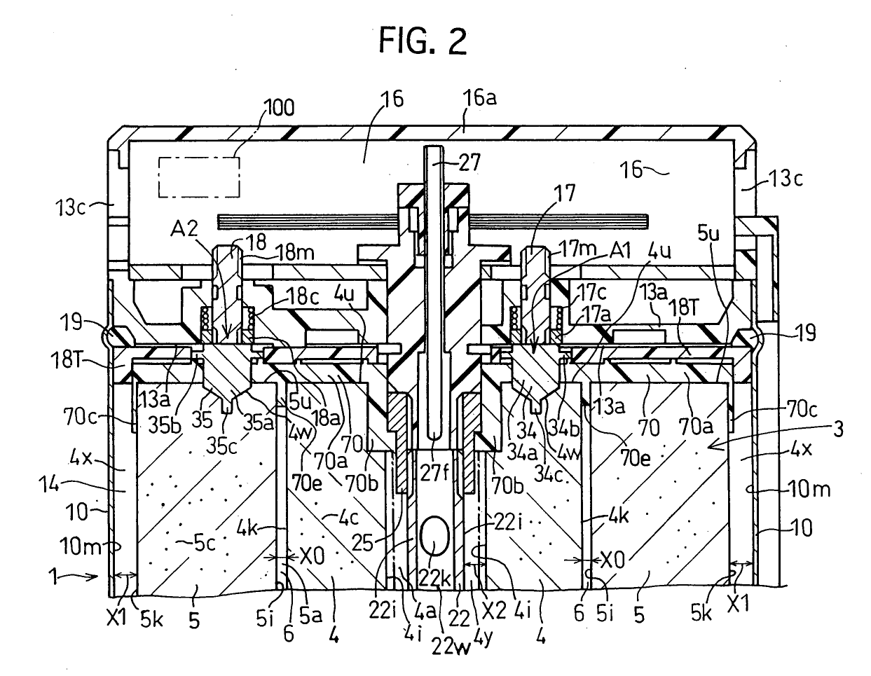

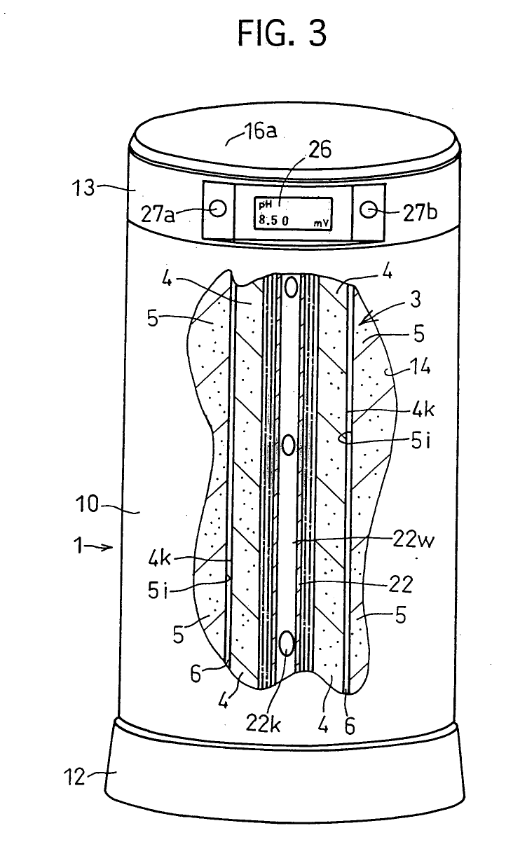

Hereinafter, the electrolytic water purifier in the embodiment 1 of the present invention will be explained concretely in accordance with FIG. 1 to FIG. 3. FIG. 1 shows an electrolytic water purifier for domestic or industrial use, and it shows the cross section of the whole construction. FIG. 2 shows the detailed cross section of the enlarged prime section of an electrolytic water purifier. FIG. 3 shows an outside drawing of a part of the cross section of the inner side of an electrolytic water purifier. The container 1 includes; a cylinder 10 as a body of the container, made of metal and formed as a cylindrical shape; a bottom cover 11 which is a circular flat plate and formed with a metal plate fixed by welding as closing the lower shaft end of the cylinder 10; a pedestal 12 which is made of resin and holding the lower end of the cylinder 10; an electric equipment container 13 which is made of resin and functions as a fixed part deposited in the upper shaft end clearance of the cylinder 10. The cylinder 10 and the bottom cover 11 are composed of a metal with high corrosion resistance, for example, stainless steel. However, this does not limit it, and at least one among aluminum alloy, titanium, titanium alloy and resin can be used. The container 1 forms a pressure container.

The container 1 has a water supplying room 14, whose cross section is circular shape, formed with inner wall surfaces of 10 m of the cylinder 10. The cross section of the water supplying room 14 is circular shape, however, this is not an only option, so rectangular shape such as a square shape can be applied. The electric equipment container 13 comprises an electric equipment room 16 for accommodating electric equipment and a lid 16a closing the upper surface clearance of the electric equipment room 16. The electric equipment container 13 is irremovably attached to the upper end of the cylinder 10 by a seal member 19, which is ring shape. The electric equipment container 13 compresses a lid member 18T made of a resin and a seal member 19 made of a resin or a rubber from the upper side, to ensure water tightness between the upper end 10u of the cylinder 10 and the electric equipment container 13.

The electric equipment container 13 includes a control section 100 to feed the first feeder terminal 34 and the second feeder terminal 35. In the rear face side 13a of the electric equipment container 13, as shown in FIG. 2, a vis 17 and a vis 18, which are formed with a conductive material such as titanium alloy, stainless steel or carbon steel are held. The vis 17 and the vis 18 are applied the alternating current voltage. The vis 17 and the vis 18 function as pressure means that suppress the first feeder terminal 34 and the second feeder terminal 35 toward the porous water-purifying member 3. The vis 17 and the vis 18 have male screw parts of 17m and 18m, which hold nut member, omitted from the figure, to connect an electric supply lead line. As shown in FIG. 2, in the male screw part of the lower side of the vis 17, the female screw part of the pressure means 17a is screwed and fixed. The spring 17c is placed between the pressure means 17a and the electric equipment container 13. The spring 17c functions as a forcing member to reduce current carrying resistance against the inside porous water-purifying member 4. Also, in the male screw part of the lower side of the vis 18, the female screw part of the pressure means 18a is screwed and held. The spring 18c is placed between the pressure means 18a and the electric equipment container 13. The spring 18c functions as an energizing member to reduce current carrying resistance against the outside porous water-purifying member 5. The spring 17c and 18c are coil springs, however, they are not limited to these, and a blade spring, a disc spring and a foaming material can be used.

In the water supplying room 14 of the cylinder 10 of the container 1, the porous water-purifying member 3 having a cylindrical shape is placed coaxially. The porous water-purifying member 3 is divided in its radial direction, and it is composed of the thick inside porous water-purifying member 4 (the first porous water-purifying member) and the thick outside porous water-purifying member 5 (the second porous water-purifying member), which is placed substantially coaxially. The inside porous water-purifying member 4 is thick and cylindrical shape, and it has a cylindrical shape, an inner wall surface 4i having a center hole 4a, which is cylindrical hollow and the outer wall surface 4k, which is cylindrical shape and placed opposite of the inner wall surface 4i. The outside porous water-purifying member 5 is thick cylindrical shape, coaxially enveloping the outer side of the inside porous water-purifying member 4. The outside porous water-purifying member 5 has a cylindrical shape, an inner wall surface 5i, which faces through the annular clearance 6 to the outer wall surface 4k of the inside the porous water-purifying member 4, and the outer wall surface 5k, which is cylindrical shape and faces to the inner wall surface 10m of the cylinder 10. The annular clearance 6 has a ring shape so that the clearance width has uniformity or approximately uniformity broadening in the circumferential direction. The annular clearance 6 enables to avoid direct contact and direct conductivity of the inside porous water-purifying member 4 and the outside porous water-purifying member 5, and it can function as an insulating space that electrically insulates them. The width of the annular clearance 6 spreads in the radial direction of the porous water-purifying member 3 and it has uniformity or approximately uniformity broadening.

The inside porous water-purifying member 4 and the outside porous water-purifying member 5 are both porous, activated carbon block filers, which are permeable sintered blocks. The sintered block is produced by the step of: forming the mixture of a powdered activated carbon, binding agent and water mixed by the predetermined weight percentage; pressurizing the mixture to become a formed body; sintering the formed body at high temperature (800-1200° C.); and setting the sintered body to the predetermined size. As to the inside porous water-purifying member 4 and the outside porous water-purifying member 5, the porosity can be selected suitably, for example, in the range of 15 to 65% by volume. The porosity is not limited to this. A fine water permeable layer with such porosity has the advantages in readily suppressing propagation of microorganism in the inside porous water-purifying member 4 and the outside porous water-purifying member 5. Moreover, it is confirmed by examinations conducted by the inventor of the present invention that generally the activated carbon containing water adsorbs a lot of oxygen in air and in water, it adsorbs a great amount of hydrogen dispersing in water after electrolyzation. As the above mentioned binding agent, a powder of thermoplastic resin (such as polyethylene), whose melting temperature is low and it does not need to be sintered or an inorganic binder such as alumina and silica can be used. The inside porous water-purifying member 4 and the outside porous water-purifying member 5 have the ability of water purification to remove hypochlorous acid (hereinafter called chlorine), etc. contained in water by chemical reaction. Also, with the pores, they have ability of water purification to adsorb disinfectant components such as trihalomethanes, etc. dissolved in water. In accordance with the inside porous water-purifying member 4 and the outside porous water-purifying member 5, the pore diameter forming a water permeable layer of the inside porous water-purifying member 4 and the outside porous water-purifying member 5 can be an average of from 0.1 to 20 micron, especially from 0.3 to 20 micron, especially from 0.3 to 15 micron. However, the pore diameter is not limited to the above ranges. As mentioned above, the inside porous water-purifying member 4 is thick walled and cylindrical shaped, having the center hole 4a. The outside porous water-purifying member 5 is thick walled and cylindrical shaped, having the center hole 5a which forms the annular clearance 6 placing the inside porous water-purifying member 4 as an axis center.

In this embodiment, as shown in FIG. 1, in order to prevent damages and the like around the shaft end of the inside porous water-purifying member 4 and the outside porous water-purifying member 5, the seal caps 70 and 71 (closing members) are bonded by an adhesive agent on the shaft end surface of the porous water-purifying member 3, which is composed by placing the inside porous water-purifying member 4 and the outside porous water-purifying member 5 approximately concentrically. The seal caps 70 and 71 are made of a high molecular material such as a resin, a rubber and the like.

The seal caps 70 and 71 have electric insulation and sealing performance. As shown in FIG. 1, the seal cap 70 of the upper side includes; a cap 70a which covers the shaft end surface (the upper end surface) of the inside porous water-purifying member 4 and the outside porous water-purifying member 5; an inner cover 70b which covers the upper side of the inner wall surface 4i of the inside porous water-purifying member 4; an outer cover 70c which covers the upper side of the outer wall surface 5k of the outside porous water-purifying member 5; a clearance holding 70e which is ring shape and holds the width of the upper side of the annular clearance 6.

As shown in FIG. 1, the seal cap 71 includes; a cap 71a which covers the shaft end surface (the lower end surface) of the inside porous water-purifying member 4 and the outside porous water-purifying member 5; an inner cover 71b which covers the lower side of the inner wall surface 4i of the inside porous water-purifying member 4; an outer cover 71c which covers the lower side of the outer wall surface 5k of the outside porous water-purifying member 5; a clearance holding 71e which is ring shaped and holds the width of the lower side of the annular clearance 6. The clearance holdings 70e and 71e of the seal caps 70 and 71 can function as a gap maintaining element to maintain the width of the annular clearance 6. Further, the seal caps 70 and 71 prevent insufficiently purified water from entering from the shaft end surface (the upper end surface 4u and the lower end surface 4d) of the inside porous water-purifying member 4 and the outside porous water-purifying member. Namely, water can efficiently enter the inside of the inside porous water-purifying member 4 and the outside porous water-purifying member 5 from the outer wall surface 4k of the inside porous water-purifying member 4 and from the outer wall surface 5k of the outside porous water-purifying member 5.

A center pipe 22 functions as an inner cylinder for water discharging and it comprises a passage 22w, formed with a pipe hole, and a plurality of passing holes 22k around the wall. The center pipe 22 is placed as a vertical type in the center hole 4a of the inside porous water-purifying member 4. In the bottom cover 11 of the container 10, an elbow 23 is fixed by welding as a coupling member. The lower end side of the center pipe 22 is screwed and fixed by a bush 24, which is connected, as a coupling member, to the male screw hole of the elbow 23. The upper side of the center pipe 22 is united by screwing the upper side of the bush 25 held by the holder 21.

The electric equipment container 13 includes openings 13c that a lead wire from an electric power supply passes-through, LED 27a and 27b (refer to FIG. 3). LED 27a is lit when voltage is applied to the inside porous water-purifying member 4 and the outside porous water-purifying member 5, and electrolyzation occurs in an electrolytic room (namely, the equivalent of the annular clearance 6 between the inside porous water-purifying member 4 and the outside porous water-purifying member 5). Accordingly, LED 27a functions as a first annunciator to signal users that electrolyzation treatment is being performed in the water purifier. LED 27b functions as a second annunciator to signal users that electrolyzation treatment is not taken place in the water purifier. Thus, LED 27b can also function as a gas adsorbing annunciator to signal that the gas produced by electrolyzation is being adsorbed to the inside porous water-purifying member 4 and the outside porous water-purifying member 5.

In accordance with the present embodiment, a display 26 (refer to FIG. 3), which indicates the amount of hydrogen produced by reduction potential, is placed on the outside of the electric equipment container 13, where is visible to users. As to sensing of reduction potential, as shown in FIG. 2, it is performed in a sensor 27 that is loaded inside the electric equipment container 13. A detector 27f of the sensor 27 is placed on the upper side of the center pipe 22. Considering dew condensation, immersion and the like, it is preferable to install an output of the sensor 27, omitted from figures, having a controller, in the electric equipment container 13 by watertight construction.

As shown in FIG. 1, beside the container 1, a water supplying member 29 that supplies water to the water supplying room 14, and a filtering member 90 that is connected through the water supplying member 29 and functions as a first purifying member for removing contaminant are installed. The water supplying member 29 is connected to a faucet of water line, omitted from the figure, through a connecting pipe 29r such as a hose, etc. When the faucet is turned on, unbleached water such as service water is supplied to the filter member 90 through the passage 29a of the water supplying member 29, and it is filtered as a pretreatment. The filtrate water with the filter member 90 flows from the hollow room 90w of the filter member 90 through the passage 29c of the water supplying member 29, to the water supplying gap 4x in the water supplying room 14 of the container 1. The water supplying gap 4x is a ring shape clearance between the outer wall surface 5k of the outside porous water-purifying member 5 and the inner wall surface 10m of the cylinder 10.

In accordance with the present embodiment, as shown in FIG. 2, the outer wall surface 4k of the inside porous water-purifying member 4 and the inner wall surface 5i of the outside porous water-purifying member 5 compose the ring shape, annular clearance 6 (clearance width X0) that functions as an electrolytic room in these axial direction. The annular clearance 6 becomes an electrolytic room and it is placed in the water passage of the inside porous water-purifying member 4 and the outside porous water-purifying member 5.

As shown in FIG. 2, in the concave part formed on the upper end surface 4u of the inside porous water-purifying member 4, a pentagon shaped, the first feeder terminal 34 that functions as the first voltage applying member, is electrically connected and held. As shown in FIG. 2, the first feeder terminal 34 is made of a conductive material (for instance, titanium, titanium alloy, alloy steel). It comprises a body 34a, inserted into the concave part 4w of the inside porous water-purifying member 4; a flange 34b spreading in the radial direction; a protruding portion 34c, convex shaped and inserted into the inside porous water-purifying member 4 in order to increase holding strength. Because of the pressure means 17a energized by the spring 17c, the pentagon shaped, the first feeder terminal 34 is conductively pressure contacting the inside porous water-purifying member 4. The pressure contacting enables to reduce current carrying resistance between the first feeder terminal 34 and the inside porous water-purifying member 4, so electric supply is ensured. By this, the inside porous water-purifying member 4 is connected to the first feeder terminal 34 to become the first electrode A1.

As shown in FIG. 2, the second feeder terminal 35, pentagon shaped and that functions as the second voltage applying member, is also made of a conductive material (for instance, titanium, titanium alloy, alloy steel). It includes a body 35a, inserted into the concave part 4w formed on the upper end surface 5u of the outside porous water-purifying member 5; a flange 35b spreading in the radial direction; a protruding portion 35c, convex shaped and inserted into the outside porous water-purifying member 5 in order to increase holding strength. Because of the pressure means 18a energized by the spring 18c, the second feeder terminal 35 is conductively pressure contacting the outside porous water-purifying member 5. The pressure contacting enables to reduce current carrying resistance between the second feeder terminal 35 and the outside porous water-purifying member 5, so electric supply is ensured. By this, the outside porous water-purifying member 5 is connected to the second feeder terminal 35, which is pentagon shaped, to become the second electrode A2. As shown in FIG. 1 and FIG. 2, the first feeder terminal 34 and the second feeder terminal 35 are placed on the same surface sides (upper end surface sides) of the porous water-purifying member 3, so it has advantages in supplying electricity to the porous water-purifying member 3.

As it can be understood from FIG. 1, the feeder terminal 34 and 35 apply potential in the radial direction of the inside porous water-purifying member 4 and the outside porous water-purifying member 5.

As indicated in FIG. 1, as well as on the lower end surface 5d of the outside porous water-purifying member 5, a concave part 4wo is formed to enable to accommodate the second feeder terminal 35. In this concave part 4wo, a seal member 4n is inserted. On the lower end surface 4d of the inside porous water-purifying member 4, a concave part 4wo is formed as well to enable to accommodate the first feeder terminal 34. In this concave part 4wo, the same type of a seal member 4n is inserted. Accordingly, even when the inside porous water-purifying member 4 and the outside porous water-purifying member 5 are inverted upside down, it is possible to attach the pentagon shaped, first feeder terminal 34 and the second feeder terminal 35 to the concave part 4wo, removed the seal member 4n. That is, the inside porous water-purifying member 4 and the outside porous water-purifying member 5 are constructed for inverting feeding as being able to supply electricity even when they are placed upside down.

In accordance with this embodiment, as voltage applied to the first electrode A1 and the second electrode A2 through the feeder terminal 34 and 35, it is possible to use, for example, the voltage having the wave shapes indicated in FIG. 4A to FIG. 4c and FIG. 5A to FIG. 5B.

When the direct current voltage is applied to the first electrode A1 and the second electrode A2, in the anode side (+pole) of direct current voltage, depending on the applied current value, there have occasionally been problems such as oxidation, elution, decrease in continuity due to forming oxide coat or damage to the surfaces, according to the condition of use even when the anode side is made of stainless steel, titanium, carbon, etc. Considering this point, it is possible to employ alternating current voltage applying system, which applies the alternating current voltage alternately repeating positive and negative voltages per unit hour to the first electrode A1 and the second electrode A2. In this case, oxidation and reduction alternately repeat many times per unit hour in the first electrode A1 and the second electrode A2. As a result, phenomena of anode oxidation and anode elution, previously occurred, can be prevented. In order to further ensure that, it is possible to form parts directly carrying current by a corrosion resisting material as well as having conductivity (for instance, titanium, titanium alloy, high corrosion stainless steel, alloy steel and the like.)

Water to be purified is supplied to the annular water supplying gap 4x between the outer wall surface 5k of the outside porous water-purifying member 5 and the inner wall surface 10m of the cylinder 10. As shown in FIG. 1, the water supplying gap 4x is communicated with the passages 29a and 29c of the water-supplying member 29. In order to actively take advantage of polarization phenomena in the cylinder 10, the gap width X1 (refer to FIG. 1) of this water supplying gap 4x can be set as narrow as possible (for instance from 2 to 5 mm, no limitation by this.)

When the direct current voltage is applied, in order to prevent occurrence of anode corrosion, the direct current voltage is directly applied to the cylinder 10 as a cathode (−pole) or when the direct current voltage is not directly applied, it is polarized as a cathode (−pole).

In this case, however, depending on the condition of use, calcium and magnesium contained in water unite ion carbonate and deposit as a product on the inner wall surface 10m of the cylinder 10 being a cathode (−pole). As time has passed, the settled product considerably deteriorates electrolyzation efficiency; further, thick deposited product is often hard to remove. When the whole cylinder 10 is made of titanium alloy, which seldom incurs anode corrosion, it is possible to readily solve the anode corrosion problem in the cylinder 10. However, it leads to cost pushing and it cannot be down to practice manufacturing when considering the cost aspect. Here, the cylinder 10 is not made of titanium alloy but it is usually made of a steel group such as stainless steel considering the cost reduces. When the polarity of cylinder 10 is set anode to dissolve the deposit, iron in the steel material composing cylinder 10 being anode is dissolved and rust or iron odor is produced, which is a problem from a practical viewpoint.

Considering the above, when the alternating current voltage, which positive and negative voltage are alternately applied many times per unit hour, is applied to the feeder terminal 34 and 35 to apply the first electrode A1 and the second electrode A2, it prevents the cylinder 10 from continuously being a cathode for a long period of time. Because of this, it is possible to suppress the excess amount of deposition of the products, like calcium carbonate and etc., in the cathode parts such as the cylinder 10. Moreover, a material of the cathode parts such as the cylinder 10 becomes irrelevant, so it is possible to form the cathode parts such as the cylinder 10 and etc. by a more reasonable metal material such as steel group like stainless steel, not by titanium alloy that leads to cost pushing.

According to the examinations by the inventor of the present invention, with the alternating current voltage applying system, electrolyzation efficiency was slightly lower than that with direct current voltage applying system. However, the predetermined current flew at about twice as much applied voltage as compared to that with the direct current voltage applying system. It enabled to produce electrolyzation gas objected at, further enabled to suppress electrolyzation corrosion and to prevent the excessive deposition of the product such as calcium carbonate. That is, with the direct current voltage applying system, it is inevitable to employ the means to avoid the polarization of the metal parts composing a water purifier. With the alternating current voltage applying system of the present invention, however, it is possible to solve the above mentioned problems.

When using a water purifier, the forcet of water line connected to the water supplying member 29 is turned on. Then, in FIG. 1, water to be purified flows through the water supplying passage 29a of the water supplying member 29 and it is supplied to the ring shaped water supplying gap 4x between the inner wall surface 10m of the cylinder 10 and the outer wall surface 5k of the outside porous water-purifying member 5. The water supplied to the water supplying gap 4x enters from the outer wall surface 5k of the outside porous water-purifying member 5 into the inside of the outside porous water-purifying member 5 along the centripetal direction (direction of the arrow W) and it is purified with the permeable layer 5c of the outside porous water-purifying member 5. Next, the purified water enters from the outer wall surface 4k of the inside porous water-purifying member 4 into the inside of the inside porous water-purifying member 4, wherein further purified with the permeable layer 4c and arrives at the center hole 4a of the inside porous water-purifying member 4. The purified water arrived at the center hole 4a of the inside porous water-purifying member 4 passes through the passing hole 22k and the passage 22w of the center pipe 22, further through the passage 23c of the elbow 23, installed as a coupling member at the lower end part of the center pipe 22. Then it is discharged outside the container from the discharging portion 36.

Moreover, when using, the alternating current voltage (frequency: 50-60 Hz) is applied to the pentagon shaped first feeder terminal 34 and the second feeder terminal 35 by the vis 17 and the vis 18. Consequently, due to electrolyzation in the annular clearance 6 between the inside porous water-purifying member 4 and the outside porous water-purifying member 5 (this gap can be set for instance, 1-10 mm or 2-4 mm, however, there are no limitations.), gas is produced in the annular clearance 6. It is considered that gaseous hydrogen gas and gaseous oxygen are produced. In this case, the inner wall surface 10m of the cylinder 10 and the outer wall surface 22i of the center pipe 22 are polarized although the voltage is not directly applied to them. Accordingly, it is possible to incur electrolyzation in between the inner wall surface 10m of the cylinder 10 and the outer wall surface 5k, facing this, of the outside porous water-purifying member 5, namely, in the water supplying gap 4x. Likewise, it is possible to incur electrolyzation in the gap 4y between the outer wall surface 22i of the center pipe 22 and the inner wall surface 4i, facing this, of the inside porous water-purifying member 4, so it is easy to ensure the amount of gas produced. This is confirmed with the examinations by the inventor.

The gas produced in the annular clearance 6 being an electrolytic room dissolves water in the annular clearance 6, etc. or stays in the upper part of the annular clearance 6 being an electrolytic room as micro bubbles and increase the pressure of the annular clearance 6 being an electrolytic room. As the pressure of the annular clearance 6 being an electrolytic room increases like this, the action of sending gas particles from the inner wall surface 5i of the outside porous water-purifying member 5 to the inside of the outside porous water-purifying member 5 and the action of sending gas particles from the outer wall surface 4k of the inside porous water-purifying member 4 to the inside of the inside porous water-purifying member 4 are increased. Here, it is considered that most of the gas produced immediately after electrolyzation is adsorbed to or stays in the pores or water passages of the porous water-purifying member 3 composing the annular clearance 6 being an electrolytic room.

As described above, gaseous hydrogen and the like are produced by electrolyzation in the annular clearance 6 being an electrolytic room. They are deposited from the upper part of the annular clearance 6 being an electrolytic room and finally, the gas pressure of the annular clearance 6 being an electrolytic room increases. That results in pushing out the most of the dwell water remained in the annular clearance 6 being an electrolytic room toward the permeable layer 4c of the inside porous water-purifying member 4 and the permeable layer 5c of the outside porous water-purifying member 5.

At the stage that the dwell water in the annular clearance 6 being an electrolytic room is pushed out to the permeable layer 4c that is the inside of the inside porous water-purifying member 4, the electrolyzation of water stops since the most of the water in the annular clearance 6 being an electrolytic room disappears. In this occasion, it is considered that the dwell water of the annular clearance 6 being an electrolytic room, does not tend to be pushed out toward the outside porous water-purifying member 5, as compared to toward the inside porous water-purifying member 4. It is considered because the outside porous water-purifying member 5 is placed close to the water supplying gap 4x having high water pressure.

Generally, the larger the width of the annular clearance 6 being an electrolytic room is, the smaller the electrode current is. Thus, as to the electrolysis in the water supplying gap 4x (gap width X1) between the inner wall surface 10m of the cylinder 10 and the outer wall surface 5k of the outside porous water-purifying member 5, and the electrolysis in the gap 4y (gap width X2) between the outer wall surface 22i of the center pipe 22 and the inner wall surface 4i of the inside porous water-purifying member 4, it is considered that electrolytic process continuously takes place when an amount of the dwell water is large in these gaps 4x and 4y. In this embodiment, however, the gaps X1 and X2 are set larger than the gap width X0 of the annular clearance 6, so electrolytic current of the electrolysis in the gaps 4x and 4y becomes small. It is only subsidiary one to the electrolysis in the annular clearance 6 being an electrolytic room.

When the inventor carried out electrolytic examination using a model type electrolytic water purifier, it took approximately four hours that the annular clearance 6 being an electrolytic room, filled with water by water supplying, became empty. When the annular clearance 6 has become empty, it is considered electrolysis ceases in the annular clearance 6. Even though the current value decreased afterwards, however, it is assumed that electrolysis was continuously performed in the above section (namely, the gaps 4x and 4y.) Additionally, in accordance with the present embodiment, when the applied voltage in the direct current is 1.5 volt, a certain electrolytic current is indicated and a certain electrolytic gases are generated.

According to the examination by the present inventor, with alternating current voltage applied, ideally 6.0 volt, which is four times larger, is necessary to achieve a certain electrolytic current of from 20 to 100 milliampere. Still this applied voltage is low voltage, so it is judged there are no problems from a power consumption aspect as well. Accordingly, when each condition is set ideally, the applied voltage of direct current can be in the range of from 1.5 to 25 volt or from 3 to 20 volt. Also, the applied voltage of alternating current can be, for instance, in the range of from 1.5 to 20 volt, especially, from 2.0 to 9.0 volt.

The electric potential differences can be, for instance, from 1.5 to 9.0 volt, especially from 3.0 to 6.0 volt between the outer wall surface 4k of the inside porous water-purifying member 4 and the inner wall surface 5i of the outside porous water-purifying member 5, the surfaces 4k and 5i are facing with each other. The electric current can be, for instance, from 20 to 80 milliampere in the potential differences between the outer wall surface 4k of the inside porous water-purifying member 4 and the inner wall surface 5i of the outside porous water-purifying member 5.

Further, a test piece cut from a part of a porous water-purifying member which is formed of the similar material to the embodiment of the present invention was examined using a pore size distribution measuring device which examines adsorption characteristics of activated carbon by using gases such as nitrogen, helium and etc. This specimen was received to a measuring room of the pore size distribution measuring device and in this state, the amount of adsorption of the activated carbon piece was measured. According to the measuring result, the higher the pressure is in the measuring room of the above measuring device, the larger the amount of occluded hydrogen of the activated carbon. Namely, it was confirmed that the characteristic of hydrogen occlusion of the activated carbon was improved. Based on this fact, in accordance with the present embodiment, a check valve 80 functioning as a valve element was placed in the tip of a hose omitted from the drawings and connected to the discharging member 36 as described above. Because of nonreturn function of the check valve 80, the pressure is maintained relatively high in the annular clearance 6 being an electrolytic room. As shown in FIG. 1, the check valve 80 comprises a valve body 80b which closes a valve mouth 80a, and an energizing spring 80c which regulates the open setting pressure, as well as energizing the valve body 80b in the direction the valve body 80b closes the valve mouth 80a. When pressure in the container 1 has become higher than the open setting pressure of the check valve 80 due to the gases generated by electrolysis, the check valve 80 opens automatically; so purified water is discharged to outside the container from the discharging member 36. In addition, it is not necessary to employ a check valve 80 depending on the case.

In accordance with the above mentioned present embodiment, when the electrolytic water purifier is not used, the container 1 is maintained as closed because of the check valve 80. Thus, adsorption of the gases that are generated by electrolysis of the dwell water in the annular clearance 6 of both porous water-purifying members 4 and 5 into the porous water-purifying member 3 is promoted. This is because when the electrolytic water purifier is not used, the container 1 tends to be kept closed by the check valve 80, and the gas pressure in the annular clearance 6 being an electrolytic room tends to increase.

Moreover, the present inventor equipped the annular clearance 6 being an electrolytic room with a digital micro pressure indicator. Then, without discharging the water, pressure variation in the annular clearance 6 being an electrolytic room was examined as time passed. According to the measuring result, when 150 minutes had passed from the beginning of the measurement, the peak pressure was indicated in the annular clearance 6 being an electrolytic room. After that point, pressure decrease was observed in the annular clearance 6 being an electrolytic room. The pressure data approximately coincided with the above mentioned open setting pressure of the check valve 80 when 150 minutes had passed from the beginning of the measurement. The pressure decrease in the annular clearance 6 being an electrolytic room after 150 minutes means progression of the gas adsorption to the inside porous water-purifying member 4 and the outside porous water-purifying member 5.

The inventor carried out the examination using an electrolytic water purifier of the present embodiment to measure variation of the amount of hydrogen in the container 1. In accordance with this examination, the outside porous water-purifying member 5 has an outside diameter of 124 mm, an inside diameter of 66 mm, a height of 200 mm: the inside porous water-purifying member 4 has an outside diameter of 62 mm, an inside diameter of 20.5 mm, a height of 200 mm. In the annular clearance 6 being an electrolytic room, the clearance of about 2 mm was formed. Then, the alternating current voltage of about 6 volt (frequency: in the range of 50-60 Hz) was applied to the first electrode A1 and the second electrode A2. The current of 83 milliampere flowed between the inside porous water-purifying member 4 and the outside porous water-purifying member 5.

In accordance with this examination, a digital oxidation reduction potentiometer was used, which can measure the amount of hydrogen by exchanging it for reduction potential. At the beginning of electrolysis, the potentiometer indicated 650 millivolt. When 30 minutes had passed, it indicated −120 millivolt since generation of hydrogen had steadily been progressing. After 12 hours had passed, it indicated −458 millivolt. As to the pH, at the beginning of discharging, it indicated pH 8.3, however, when the amount of the discharged water became over 1 litter, it returned to 7.5 pH.

When the direct current is applied, even with soft water, calcium bicarbonate contained in unpurified water has become calcium carbonate after long period of use. This deposits on the cathode side (−pole) of the purifier as a product to form an insulating coat. It may cause the problem that electrolysis ceases in the annular clearance 6 being an electrolytic room. According to this examination, since the alternating current voltage that the positive voltage and the negative voltage are alternately inverted with 50 to 60 cycles is applied, oxidation and reduction are repeated, so it is possible to suppress the deposition of products such as calcium carbonate. In fact, when the electrolytic water purifier was disassembled and examined after 4 months had passed, there was no trace of products at all. It was proved that applying the alternating current voltage was remarkably effective.

Under the usual circumstances, hydrogen rarely exists in the air, so there is little chance that hydrogen is dissolved in water. Conventionally, an oxidation-reduction potentiometer with a glass reference electrode is used for alkali ion generated water and etc., similar to this. Since it measures by infusing inside liquid from the tip of a glass electrode, it is necessary to refill the inside liquid constantly for yearlong measurement. Under these circumstances, the inventor found out that there was an obvious correlation between oxidation-reduction potential and pH, and developed a sensor that could function as a solid state type pH measuring apparatus without inside liquid. The sensor 27 is plugged from the electric equipment container 13 into the center hole 4a that is divided by the inner wall surface 4i of the inside porous water-purifying member 4. Using a microcomputer, oxidation-reduction potential is calculated from the pH value and the result is indicated on the display 26 placed on the outside of the electric equipment container 13. The detecting section 27f of the sensor 27 is inserted into the bush 25, which is screwed in the upper side of the center pipe 22. A microcomputer is equipped in the electric equipment room 16 of the electric equipment container 13 and connected to the display 26.

As described above, in accordance with the present embodiment, the porous water-purifying member 3 is divided into two, the inside porous water-purifying member 4 and the outside porous water-purifying member 5 in a radial direction to form the annular clearance 6. Further, the inside porous water-purifying member 4 is connected to the first feeder terminal 34 to become the first electrode A1, as well as the outside porous water-purifying member 5 is connected to the second feeder terminal 35 to become the second electrode A2. According to this construction, it is possible to enlarge the surface area of the inner wall surface 5i of the outside porous water-purifying member 5 that forms the annular clearance 6 being an electrolytic room, as well as to enlarge the surface area of the outer wall surface 4k of the inside porous water-purifying member 4. Thus, it is possible to enlarge electrolytic area in the porous water-purifying member 3 and it has advantages in heightening the ability of electrolyzation in the annular clearance 6 being an electrolytic room. Moreover, it is possible to enlarge the gas penetration area of the porous water-purifying member 3 that adsorbs gases, so it has advantages in adsorbing the gas produced by electrolyzation of water in the annular clearance 6 being an electrolytic room to the pores of the porous water-purifying member 3. Generally, it is said that the gas such as hydrogen, etc. immediately after produced by electrolyzation is activated and has good influences on organism. Especially, according to the present embodiment, since the annular clearance 6 used as an electrolytic room is formed between the porous water-purifying members 4 and 5, it has advantages in effectively adsorbing the gas immediately after produced by electrolyzation, which is activated and said to be good for organism, to the porous water-purifying member 3.

### Embodiment 2

The second embodiment basically has the same constructions as the above described embodiment. The alternating current voltage or the direct current voltage is applied to the first feeder terminal 34 and the second feeder terminal 35. It basically has the same action and effect as the above described embodiment. In this embodiment, an emphasis is placed on the captivation of fungi and the like. As to the outside porous water-purifying member 5, it is set to have high porosity with density. The average pore diameter is set to be smaller than the average pore diameter of the inside porous water-purifying member 4 (for instance, from 0.1 to 1 micron, especially 0.3 micron.) In accordance with such outside porous water-purifying member 5, the captivation of fungi and the like is fine, however, the pressure loss in water supplying increases and the amount of discharging water per unit hour decreases.

As to the inside porous water-purifying member 4, the porosity is set to be slightly lower. The average pore diameter is set to be larger than the average pore diameter of the outside porous water-purifying member 5M (for instance, from 8 to 100 micron, from 8 to 20 micron, or from 8 to 10 micron) to reduce the pressure loss in water supplying and to increase the amount of discharging water per unit hour. By combining the inside porous water-purifying member 4 and the outside porous water-purifying member 5 having such characteristics, it is possible to ensure the captivation as well as the amount of discharging water per unit hour. Especially, in the water supplying room 14, the water pressure affects along the centripetal direction of the inside porous water-purifying member 4 and the outside porous water-purifying member 5 (direction of the arrow W.) Since the outside porous water-purifying member 5 is set to be dense and strong, it has advantages in dealing with such water pressure. Additionally, the average pore diameter is not limited to the above mentioned value.

### Embodiment 3

The third embodiment basically has the same constructions as the above described embodiments. The alternating current voltage or the direct current voltage is applied to the first feeder terminal 34 and the second feeder terminal 35. It basically has the same action and effect as the above described embodiments. In this embodiment, the inside porous water-purifying member 4 is set to have high porosity with density. The average pore diameter is set to be smaller than the average pore diameter of the outside porous water-purifying member 5. In accordance with such inside porous water-purifying member 4, the captivation of fungi and the like is good, however, the pressure loss in water supplying increases and the amount of discharging water per unit hour decreases due to its precision despite the high porosity.

As to the outside porous water-purifying member 5, the porosity is set to be slightly lower and the average pore diameter is set to be larger than the average pore diameter of the inside porous water-purifying member 4 to reduce the pressure loss in water supplying and to increase the amount of discharging water per unit hour. By combining the inside porous water-purifying member 4 and the outside porous water-purifying member 5 having such characteristics, it is possible to ensure the captivation as well as the amount of discharging water per unit hour.

### Embodiment 4

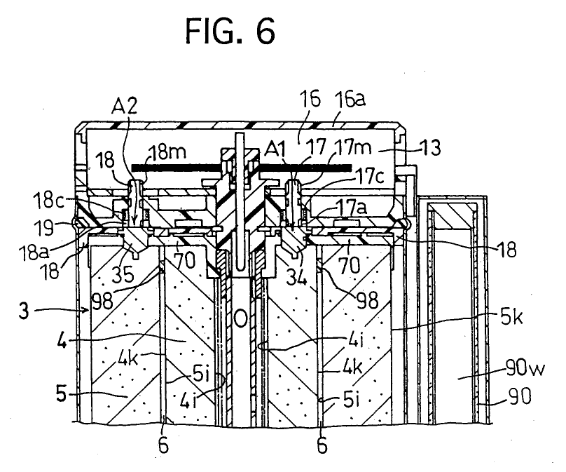

FIG. 6 shows the fourth embodiment. The fourth embodiment basically has the same constructions as the above described embodiments. The alternating current voltage or the direct current voltage is applied to the first feeder terminal 34 and the second feeder terminal 35. It basically has the same action and effect as the above described embodiments. In this embodiment as well, the porous water-purifying member 3 is divided into the inside porous water-purifying member 4 and the outside porous water-purifying member 5 in a radial direction to form the annular clearance 6. A spacing member 98 intervenes as a clearance maintaining element between the outer wall surface 4k of the inside porous water-purifying member 4 and the inner wall surface 5i of the outside porous water-purifying member 5. The width of the annular clearance 6 being an electrolytic room is finely maintained by the spacing member 98. It has advantages in performing electrolysis in the annular clearance 6 stably for a long period of time. The same spacing member is installed in the down side of the porous water-purifying member 3 although it is not shown in the figures. The spacing member 98 can be formed as a ring shape, however, this is not the only option. As to the material of the spacing member 98, high molecular materials such as resin, etc., ceramic materials and the like can be adopted. It is preferable to have high electric insulation and corrosion resistance.

### Embodiment 5

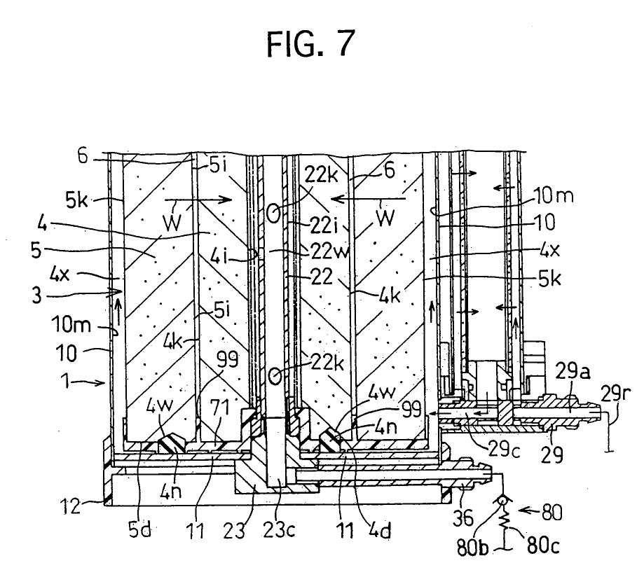

FIG. 7 shows the fifth embodiment. The fifth embodiment basically has the same constructions as the above described embodiments. The alternating current voltage or the direct current voltage is applied to the first feeder terminal 34 and the second feeder terminal 35. It basically has the same action and effect as the above described embodiments. In this embodiment as well, the porous water-purifying member 3 is divided into the inside porous water-purifying member 4 and the outside porous water-purifying member 5 in a radial direction to form the annular clearance 6. A spacing member 99 intervenes as a clearance maintaining element between the outer wall surface 4k of the inside porous water-purifying member 4 and the inner wall surface 5i of the outside porous water-purifying member 5. The spacing member 99 and the seal cap 71 are formed as one unit. The width of the annular clearance 6 being an electrolytic room is finely maintained by the spacing member 99. It has advantages in performing electrolysis in the annular clearance 6 stably for a long period of time. The same spacing member is formed as one unit with the other seal cap 70. The spacing member 99 can be formed as a ring shaped, however, this is not the only option.

### Embodiment 6

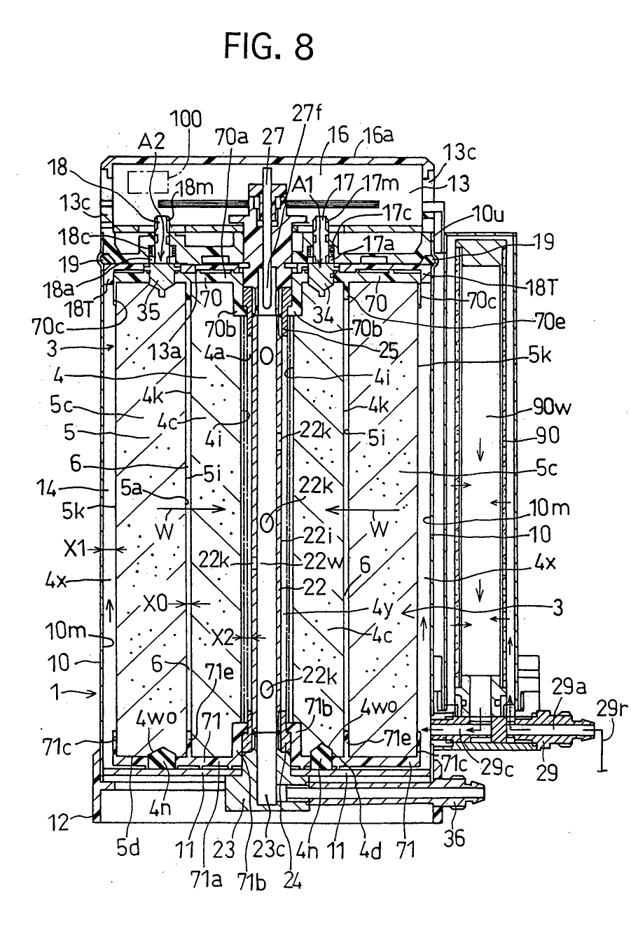

FIG. 8 shows the sixth embodiment. The sixth embodiment basically has the same constructions as the above described embodiments. The direct current voltage (voltage: for instance, 1.5 to 20 volt) is applied to the first feeder terminal 34 and the second feeder terminal 35. It basically has the same action and effect as the above described embodiments. In this embodiment as well, the porous water-purifying member 3 is divided into the inside porous water-purifying member 4 and the outside porous water-purifying member 5 in the radial direction to form the annular clearance 6. A check valve 80 is not installed.

In accordance with this embodiment, by applying the direct current voltage to the first feeder terminal 34 and the second feeder terminal 35, voltage is applied to the first electrode A1 and the second electrode A2. Generally, the first feeder terminal 34 is set to be as anode (+pole), the second feeder terminal 35 as cathode (−pole) and the inside porous water-purifying member 4 to be as anode (+pole), the outside porous water-purifying member 5 as cathode (−pole).

Depending on the case, it is possible to set the first feeder terminal 34 as cathode (−pole), the second feeder terminal 35 as anode (+pole), and the inside porous water-purifying member 4 as cathode (−pole), the outside porous water-purifying member 5 as anode (+pole).

### Embodiment 7

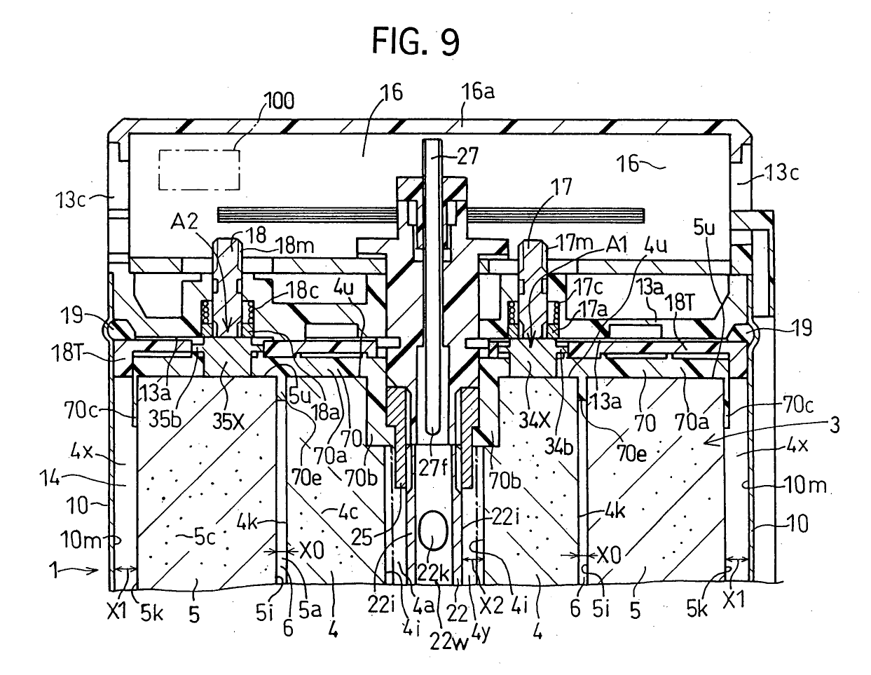

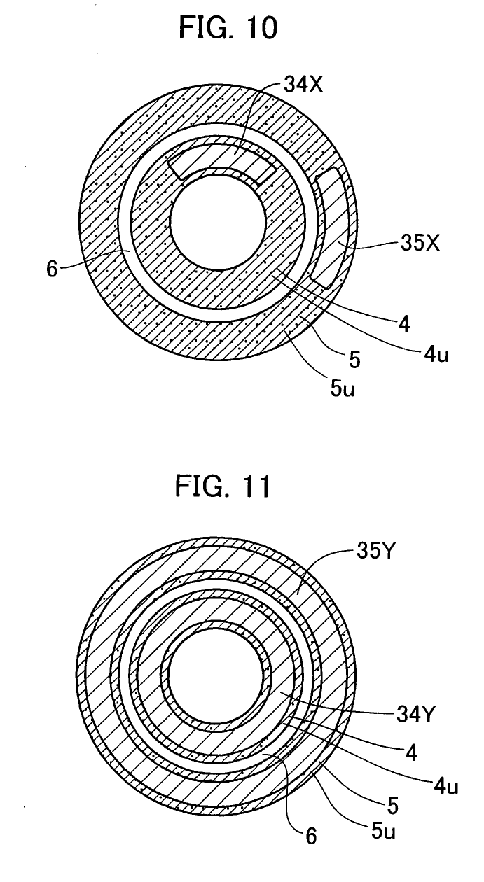

FIGS. 9 and 10 show the seventh embodiment. The seventh embodiment basically has the same constructions as the above described embodiments and it basically has the same action and effect as the above described embodiments. In this embodiment as well, the porous water-purifying member 3 is divided into the inside porous water-purifying member 4 and the outside porous water-purifying member 5 in the radial direction to form the annular clearance 6. In accordance with this embodiment, by applying the alternating current voltage or the direct current voltage to the first feeder terminal 34X and the second feeder terminal 35X, voltage is applied to the first electrode A1 and the second electrode A2. Because of the spring 17c as a forcing member, the first feeder terminal 34X pressure contacts the upper end surface 4u, which is the shaft end surface of the inside porous water-purifying member 4. Because of the spring 18c as a forcing member, the second feeder terminal 35X pressure contacts the upper end surface 5u, which is the shaft end surface of the outside porous water-purifying member 5. In this case, the first feeder terminal 34X and the second feeder terminal 35X do not have to bite into the inside porous water-purifying member 4 and the outside porous water-purifying member 5. As shown in FIG. 10, in the upper end surface 4u, which is the shaft end surface of the inside porous water-purifying member 4, the first feeder terminal 34X spreads over certain distances along the circumferential direction and circular shaped, so the conductive area is ensured. In the upper end surface 5u, which is the shaft end surface of the outside porous water-purifying member 5, the second feeder terminal 35X spreads over certain distances along the circumferential direction and circular shaped, so the conductive area is ensured. The alternating current voltage or the direct current voltage is applied to the first feeder terminal 34X and the second feeder terminal 35X.

### Embodiment 8

FIG. 11 shows the eighth embodiment. This embodiment basically has the same constructions as the above described embodiments and it basically has the same action and effect as the above described embodiments. In accordance with this embodiment, the first feeder terminal 34Y is formed as a ring shape coaxial to the inside porous water-purifying member 4. It pressure contacts the upper end surface 4u, which is the shaft end surface of the inside porous water-purifying member 4. The second feeder terminal 35Y is formed as a ring shape coaxial to the outside porous water-purifying member 5. It pressure contacts the upper end surface 5u, which is the shaft end surface of the outside porous water-purifying member 5. The alternating current voltage or the direct current voltage is applied to the first feeder terminal 34Y and the second feeder terminal 35Y. Since the feeder terminals 34Y and 35Y are ring shaped, it has advantages in leveling the current density.

### Other Embodiments

The present invention is not limited to the embodiments that are described above and shown in the figures. Appropriate changes and modifications can be made thereto without departing from the split of scope of the present invention. For example, the above described each shape, construction, size, material and the like of parts are not restricted to those described above. The applied voltage value, current value and etc. are not limited to those indicated above. As unpurified raw water, it is not limited to tab water, water from well can be used. The first feeder terminal 34 and the second feeder terminal 35 do not have to be a pentagon shape, other shapes and constructions can be applied as long as being able to feed to the porous water-purifier members. Water runs in the centripetal direction of the porous water-purifier member 3, however, it can run reversely. In the embodiment shown in FIG. 1, the first feeder terminal 34 and the second feeder terminal 35 are placed on the upper end surface 4u of the inside porous water-purifying member 4 and the upper end surface 5u of the outside porous water-purifying member 5 and feeding from the upper side of the inside porous water-purifying member 4 and the outside porous water-purifying member 5. However, it is possible to feed from the lower side of the inside porous water-purifying member 4 and the outside porous water-purifying member 5. Or it is also possible to feed from both the upper side and the lower side of the. inside porous water-purifying member 4 and the outside porous water-purifying member 5. In the above described embodiments, the inside porous water-purifying member 4 and the outside porous water-purifying member S are cylindrical shape, however, depending on the case, they can be conical shape or rectangular shape. Additionally, it is preferable to conduct an earth treatment when necessary.

Additional remarks

The following technical idea can be conceived from the above description.

In each claim, an electrolytic water purifier comprises an electrolytic room placed between the both porous water-purifying members, wherein the electrolytic room is placed in the approach route of water of the porous water-purifying member.

In each claim, an electrolytic water purifier characterizes in that the porous water-purifying members are made of a material mainly composed of activated carbon and binding agent, pressure formed and calcined.

In each claim, an electrolytic water purifier characterizes in that the porous water-purifying members have a plurality of pores whose average diameter is 0.1-20 micron, especially 0.3-15 micron, more specifically 0.3-10 micron.

In each claim, an electrolytic water purifier characterizes in that the porous water-purifying members are block shape forming with the porosity of from 15% to 65%, having gas penetration resistance, wherein gas pressure of the annular clearance being an electrolytic room can be easily increased due to the gas produced in the annular clearance being an electrolytic room. Since the porous water-purifying members have many pores and gas penetration resistance, the pressure in the electrolytic room is easily increased, the gas in the annular clearance being an electrolytic room can easily enter the porous water-purifying members.

In each claim, an electrolytic water purifier characterizes in that the porous water-purifying members are cylindrical shape with a center hole, wherein a metal center pipe is arranged in the center hole of the porous water-purifying members substantially coaxially with ring shape clearance, when voltage is applied to the porous water-purifying members, the center pipe can be polarized and the clearance between the outer wall surface of the center pipe and the inner wall surface of the cylindrical portion of the porous water-purifying members can function as an electrolytic room.

In each claim, an electrolytic water purifier characterizes in that as voltage is applied to the porous water-purifying members, the inner wall surface of the cylinder can be polarized and the clearance between the outer wall surface of the porous water-purifying members and the inner wall surface of the center pipe can function as an electrolytic room.

In each claim, an electrolytic water purifier characterizes in that the feeder terminals are arranged in the same side of the porous water-purifying members. It has advantages in feeding to the porous water-purifying members.

In each claim, an electrolytic water purifier characterizes in that the voltage applied to the porous water-purifying members (the alternating current or the direct current voltage) is in the range of 1.5-25 volts, especially 2-20 volts.

In each claim, an electrolytic water purifier characterizes in that the electric current is 10-100 milliampere in the potential differences between the porous water-purifying members that the voltage is applied.

In each claim, an electrolytic water purifier characterizes in having a display, which indicates the amount of hydrogen produced in the container. The users can grasp the amount of hydrogen produced in the container.

In each claim, an electrolytic water purifier characterizes in having a display, which indicates oxidation-reduction potential by calculating the amount of hydrogen produced in the container from the pH value.

In each claim, an electrolytic water purifier characterizes in having a check valve to keep the pressure in the electrolytic room high, when pressure in the container has become higher than the open setting pressure of the check valve due to the gases generated by electrolysis, the check valve opens, so purified water can be discharged from the discharging member, whereas when pressure in the container has become lower than the open setting pressure of the check valve, the check valve is closed. It enables to maintain the pressure in the container high.

An electrolytic water purifier comprises a container having a water supplying room which is divided with inner walls; a porous water-purifying member having many pores with water purifying ability, disposed in the water supplying room of the container; a water supplying portion that supplies water to the water supplying room of the container; a discharging portion that discharges the purified water with the porous water-purifying member in the water supplying room of the container to outside the container,
wherein the porous water-purifying member is divided into at least two porous water-purifying members to form the annular clearance, wherein the first porous water-purifying member is connected to the first feeder terminal to be as the first electrode as well as the second porous water-purifying member is connected to the second feeder terminal to be as the second electrode, wherein by applying voltage to the first and second electrodes, water in the annular clearance is electrolyzed and the produced gas is adsorbed to the pores of the porous water-purifying member.

In each claim, an electrolytic water purifier characterizes in that the amount of discharging water per unit hour of the porous water-purifying member arranged outside is larger than that of the porous water-purifying member arranged inside.

In each claim, an electrolytic water purifier characterizes in that the porous water-purifying member arranged outside is more precise and the amount of discharging water per unit hour is smaller than that of arranged inside.

1. An electrolytic water purifier comprising: a container having an inner wall surface and a water supplying room formed of the inner wall surface;
a porous water-purifying member having a plurality of pores with water purifying ability, disposed in said water supplying room of said container; and
a water supplying portion placed in said container and supplying water to said water supplying room of said container;
a discharging portion placed in said container and discharging water purified with said porous water-purifying member of the water supplying room of said container to outside the container;
wherein said porous water-purifying member is divided in a radial direction into at least a first porous water-purifying member and a second porous water-purifying member to form an annular clearance, and
the first porous water-purifying member is connected to a first feeder terminal to be as a first electrode and the second porous water-purifying member is connected to a second feeder terminal to be as a second electrode, and
by applying voltage to said first and second electrodes, water in said annular clearance is electrolyzed to produce gas to be adsorbed to the pores of said porous water-purifying member.

2. The electrolytic water purifier set forth in claim 1, wherein said first electrode comprises a first voltage applying portion which applies the alternating current or the direct current to said first electrode and said second electrode comprises a second voltage applying portion which applies the alternating current or the direct current to said second electrode.

3. The electrolytic water purifier set forth in claim 2, wherein frequency of the alternating current is 10-500 Hz.

4. The electrolytic water purifier set forth in claim 2, wherein the alternating current is biased by adding the direct current components to the alternating current components.

5. The electrolytic water purifier set forth in claim 1, wherein said annular clearance has a ring shape.

6. The electrolytic water purifier set forth in claim 1, wherein the width of said annular clearance is 30 mm or less.

7. The electrolytic water purifier set forth in claim 1, wherein the base material of said porous water-purifying member is activated carbon.

8. The electrolytic water purifier set forth in claim 1, wherein said porous water-purifying member is formed of a permeable sintered block by sintering a formed body containing activated carbon and a binding agent.

9. The electrolytic water purifier set forth in claim 1, wherein said first porous water-purifying member is cylindrical shaped, having an outer surface and an inner surface, and said second porous water-purifying member is placed in the outer side of said first porous water-purifying member coaxially, cylindrical shaped and having an outer surface and an inner surface, and
said annular clearance is formed by the outer surface of said first porous water-purifying member and the inner surface of said second porous water-purifying member.

10. The electrolytic water purifier set forth in claim 1, wherein said first porous water-purifying member is cylindrical shaped, having an outer surface and an inner surface, and said second porous water-purifying member is placed in the outer side of said first porous water-purifying member coaxially, cylindrical shaped and having an outer surface and an inner surface, and wherein
said annular clearance is formed by the outer surface of said first porous water-purifying member and the inner surface of said second porous water-purifying member, and wherein
comprising a center pipe arranged coaxially in the space divided by the inner surfaces of said first porous water purifying member, having a surrounding wall forming a passage water purified with said second porous water-purifying member and said first porous water-purifying member runs, and a plurality of holes formed in said surrounding wall and connected through to said passage, and
said passage of said center pipe is connected through to said discharging portion in order to supply said purified water to said discharging portion.

11. The electrolytic water purifier set forth in claim 1, wherein said porous water-purifying member is cylindrical shaped, and water supplied from said water supplying portion to said water supplying room runs inside of said second porous water-purifying member and said first porous water-purifying member along a centripetal direction of said porous water-purifying members.

12. The electrolytic water purifier set forth in claim 1, wherein a clearance maintaining element is disposed in said container to keep the clearance width of said annular clearance between said first porous water-purifying member and said second porous water-purifying member.

13. The electrolytic water purifier set forth in claim 1, wherein said first porous water-purifying member is tubular shaped, having a shaft end surface, and said second porous water-purifying member is tubular shaped, having a shaft end surface, and
a clearance maintaining element is disposed in said container to keep the clearance width of said annular clearance between said first porous water-purifying member and said second porous water-purifying member, and
a seal cap is arranged to close said shaft end surfaces of said first porous water-purifying member and said second porous water-purifying member, and
wherein said seal cap comprises said clearance maintaining element to keep the clearance width of said annular clearance between said first porous water- purifying member and said second porous water-purifying member.

14. The electrolytic water purifier set forth in claim 1, wherein a valve element is equipped in said container to increase a gas-adsorbing amount in said porous water-purifying members by maintaining a gas pressure in said water supplying room.

15. The electrolytic water purifier set forth in claim 1, wherein said container is tubular shaped, having an inner surface, said porous water-purifying member is tubular shaped, having an outer surface, and a water supplying clearance is formed in the outside of the outer surface of said porous water-purifying member by said inner surface of said container and said outer surface of said porous water-purifying member, said water supplying clearance is connected through said water supplying portion.

16. The electrolytic water purifier set forth in claim 2, wherein said first voltage applying portion is a first feeder terminal, formed of conductive material, which is electrically conductive to said first porous water-purifying member, and said second voltage applying portion is a second feeder terminal, formed of conductive material, which is electrically conductive to said second porous water-purifying member.

17. The electrolytic water purifier set forth in claim 2, wherein said first voltage applying portion is a first feeder terminal, formed of conductive material, which is electrically conductive to said first porous water-purifying member, and said second voltage applying portion is a second feeder terminal, formed of conductive material, which is electrically conductive to said second porous water-purifying member, and
said first porous water-purifying member is placed inside and said second porous water-purifying member is placed outside coaxially,
said first feeder terminal is set to be as anode (+pole) and the second feeder terminal is set to be as cathode (−pole).

18. The electrolytic water purifier set forth in claim 2, wherein said first voltage applying portion is a first feeder terminal, formed of conductive material, which is electrically conductive to said first porous water-purifying member, and said second voltage applying portion is a second feeder terminal, formed of conductive material, which is electrically conductive to said second porous water-purifying member, and
said first porous water-purifying member is placed inside and said second porous water-purifying member is placed outside coaxially,
said first feeder terminal is set to be as cathode (−pole) and the second feeder terminal is set to be as anode (+pole).

19. The electrolytic water purifier set forth in claim 15, wherein at least one of said first feeder terminal and said second feeder terminal bites into the inside of said porous water-purifying member for improving conductivity.

20. The electrolytic water purifier set forth in claim 16, wherein at least one of said first feeder terminal and said second feeder terminal pressure contacts on the surface of said porous water-purifying member with an energizing member for increasing conductivity.

21. The electrolytic water purifier set forth in claim 16, wherein said porous water-purifying member has an upper surface and at least one of said first feeder terminal and said second feeder terminal pressure contacts on the upper surface of said porous water-purifying member.

22. The electrolytic water purifier set forth in claim 16, wherein said first porous water-purifying member and said second porous water-purifying member are placed coaxially, cylindrical shaped, having shaft end surfaces,
at least one of said first feeder terminal and said second feeder terminal spreads over in a circular shape along a circumferential direction in the shaft end surface of said porous water-purifying member to increase a conductive area.

23. The electrolytic water purifier set forth in claim 16, wherein said first porous water-purifying member and said second porous water-purifying member are placed coaxially, cylindrical shaped, having shaft end surfaces,
at least one of said first feeder terminal and said second feeder terminal spreads over in a continuous ring shape along the circumferential direction in the shaft end surface of said porous water-purifying member to increase a conductive area.
